(19) United States
(12) Patent Application Publication
(10) Pub. No.: US 2024/0051333 A1
(43) Pub. Date: Feb. 15, 2024

(54) SPOKE

(71) Applicant: TIEN HSIN INDUSTRIES CO., LTD., Taichung City (TW)

(72) Inventor: WEI-CHIH WEI, Taichung City (TW)

(21) Appl. No.: 17/883,640

(22) Filed: Aug. 9, 2022

(51) Int. Cl. B60B 1/04

(52) U.S. Cl. CPC B60B 1/041; B60B 2310/204; B60B 2360/32; B60B 2360/341

(57) ABSTRACT

A spoke includes an axle body and two connecting elements. The axle body has a middle segment and two connecting segments. The two connecting segments are respectively connected to two opposite sides of the middle segment. The two connecting segments each have a first peripheral surface, and the two first peripheral surfaces each are formed with a friction enhancing structure. The two connecting elements respectively wrap at least a part of the two friction enhancing structures by means of injection molding. The two connecting elements each have a second peripheral surface facing away from the axle body, and the two second peripheral surfaces each are formed with a connecting structure.

### FIELD OF THE INVENTION

The present disclosure relates to a component of a bicycle, and more particularly to a spoke.

### BACKGROUND OF THE INVENTION

Cycling has the functions of sightseeing and fitness, and the fitness intensity can be adjusted according to the route selection or the type of bicycle. Therefore, more and more people join cycling in recent years. Generally, mountain bike is more suitable for climbing and off-road roads, and fitness intensity is greater. On the other hand, road bike is more suitable for long-distance riding on general roads, and many people choose road bikes for sightseeing or commuting.

Generally, a bicycle includes components such as a frame, a derailleur, a brake, wheels, spokes etc. The component located at the center of the wheel is called a coaster hub, and the spoke is in a shape of rod and connected between the coaster hub and the wheel. Specifically, the wheel may be slightly deformed due to being pressed during moving, so that the spoke may be pulled along its axial direction. Hence, the spoke must have sufficient structural strength to against the axial-direction tensile force so as to improve the durability of the bicycle.

### SUMMARY OF THE INVENTION

The present disclosure provides a spoke with improved structural strength to against the axial-direction tensile force.

The spoke provided by the present disclosure includes an axle body and two connecting elements. The axle body has a middle segment and two connecting segments. The two connecting segments are respectively connected to two opposite sides of the middle segment. The two connecting segments each have two first peripheral surfaces, wherein the two first peripheral surfaces each are formed with a friction enhancing structure. The two connecting elements respectively wrap at least a part of the two friction enhancing structures by means of injection molding. The two connecting elements each have a second peripheral surface facing away from the axle body, and the two second peripheral surfaces each are formed with a connecting structure.

In an embodiment of the present disclosure, the friction enhancing structures each include, for example, a plurality of concave portions. The concave portions are disposed at intervals along an axial direction of the axle body, and a convex portion is formed between each two adjacent concave portions.

In an embodiment of the present disclosure, the convex portions and the concave portions make the first peripheral surface have a wavy surface.

In an embodiment of the present disclosure, the two connecting elements each can further extend to wrap a part of the middle segment.

In an embodiment of the present disclosure, a material of the connecting element includes, for example, thermoplastic.

In an embodiment of the present disclosure, a material of the connecting element can includes epoxy, PEEK, PAEK or PEKK.

In an embodiment of the present disclosure, the connecting structure each can be thread. An axis of each of the two connecting elements is located on an imaginary plane. The connecting structure is constructed by a plurality of sawtooth threads when viewing at the imaginary plane. The sawtooth threads each have a tooth tip. The sawtooth threads each are divided into a first angle and a second angle by a connecting line passing through a central point of the respective tooth tips and perpendicular to the axis. The first angle is close to the middle segment, the second angle is away from the middle segment, and the first angle is less than the second angle.

In an embodiment of the present disclosure, the axle body can have two end surfaces opposite to each other, and the two friction enhancing structures are respectively located between the two end surfaces and the middle segment. The two connecting elements further respectively extend to wrap the two end surfaces.

In an embodiment of the present disclosure, materials of the axle body include, for example, fiber composite or thermoplastic.

In an embodiment of the present disclosure, the middle segment and the two connecting segments can be integrally formed.

In the spoke of the present disclosure, the connecting elements wraps and is fixed to the axle body by means of injection molding, and the area of the axle body wrapped by the connecting element is disposed with the friction enhancing structure to enhance the friction between the connecting element and the axle body. Thus, based on the aforementioned structure, the connecting element can firmly wrap and be fixed to the axle body. Therefore, when the spoke is subjected to an axial-direction tensile force, the connecting element is not easily separated from the axle body, thereby improving the structural strength of the spoke against the axial-direction tensile force.

The following embodiments are given with the accompanying drawings in order to make the above-mentioned and other purposes, features and advantages of the present disclosure be more obvious, and detailed descriptions are as follows.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic diagram of a spoke according an embodiment of the present disclosure;

FIG. 2 is a schematic diagram of the spoke of FIG. 1 in which an axle body and two connecting elements are separated;

FIG. 3 is a schematic diagram of the spoke of FIG. 1 in which one of the two connecting elements is fixed to the axle body;

FIG. 4 is a schematic cross-sectional diagram of the spoke of FIG. 3 fixed to a nipple; and

FIG. 5 is an enlarged schematic diagram of one of sawtooth threads of the connecting structure of FIG. 4.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

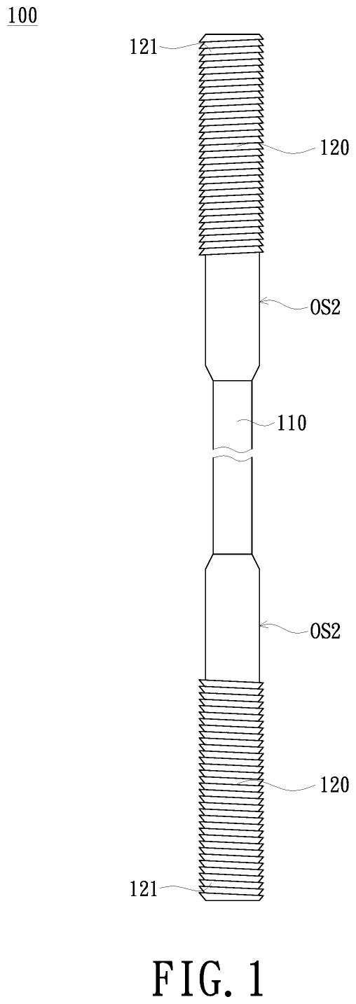

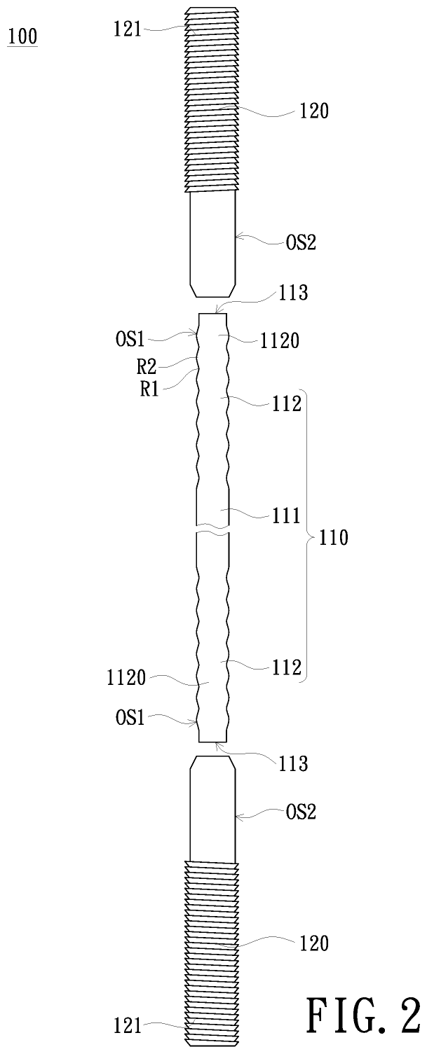

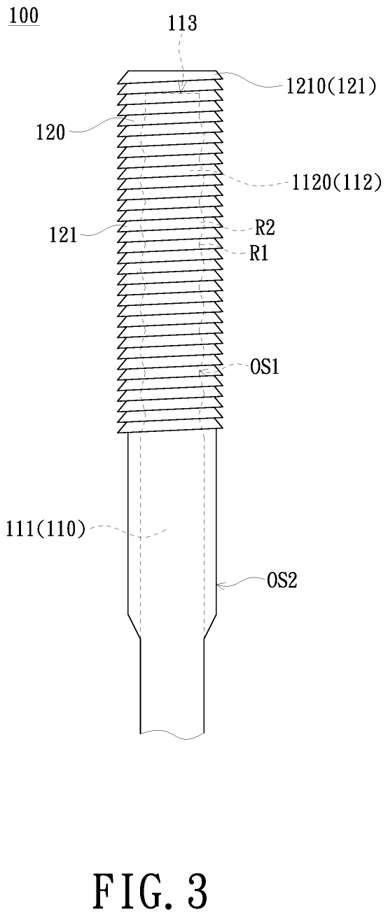

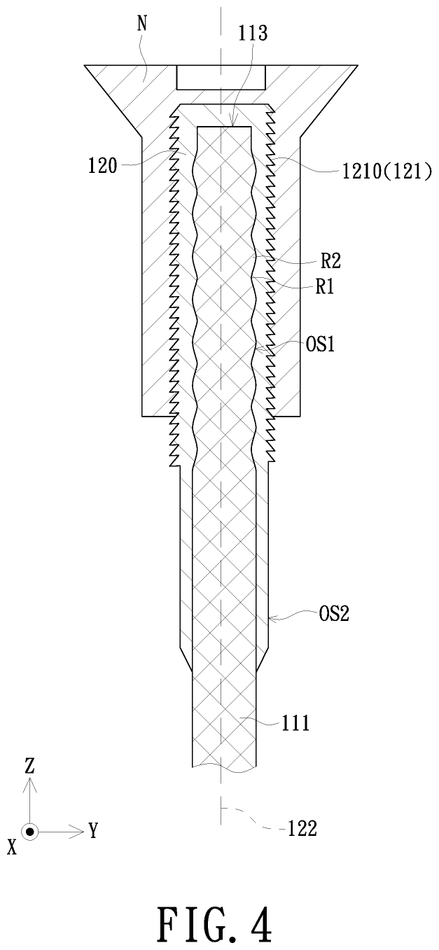

FIG. 1 is a schematic diagram of a spoke according to an embodiment of the present disclosure. FIG. 2 is a schematic diagram of the spoke of FIG. 1 in which an axle body and two connecting elements are separated. FIG. 3 is a schematic diagram of the spoke of FIG. 1 in which one of the two connecting elements is fixed to the axle body. FIG. 4 is a schematic cross-sectional diagram of the spoke of FIG. 3 fixed to a nipple. Please refer to FIGS. 1, 2 and 3 first. The spoke 100 includes an axle body 110 and two connecting elements 120. The axle body 110 has a middle segment 111 and two connecting segments 112 (shown in FIGS. 2 and 3). The two connecting segments 112 are respectively connected to two opposite sides of the middle segment 111. The two connecting segments 112 each have a first peripheral surface OS1. The two first peripheral surfaces OS1 each are formed with a friction enhancing structure 1120. The two connecting elements 120 each wrap at least a part of the respective friction enhancing structure 1120 by means of injection molding. The two connecting elements 120 each have a second peripheral surface OS2 facing away from the axle body 110. The two second peripheral surfaces OS2 each are formed with a connecting structure 121.

Please refer to FIGS. 3 and 4. The material of the connecting element 120 in this embodiment includes, for example, thermoplastic, so as to facilitate to perform the injection molding process. For example, the material of the connecting element 120 may include epoxy, polyetheretherketone (PEEK), polyaryletherketone (PAEK), polyetherketoneketone (PEKK), but the present disclosure is not limited thereto. In this embodiment, the two connecting elements 120 each may further extend to wrap a part of the middle segment 111, so that the two connecting elements 120 can be more firmly fixed to the axle body 110, thereby further improving the structural strength of the spoke 100 against the axial-direction (substantially parallel to direction Z in FIG. 4) tensile force.

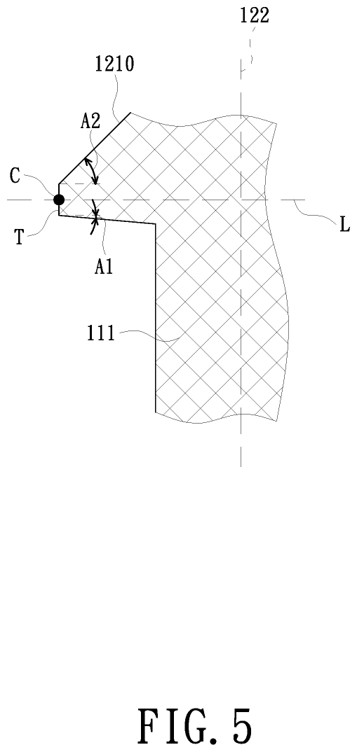

Please continue to refer to FIG. 4. In this embodiment, the connecting element 120 may be fixed to a wheel of a bicycle (not shown) via a nipple N. The connecting structure 121 of the connecting element 120 may be thread, and the nipple N may have an inner thread corresponding to the connecting structure 121. In other embodiments, it can be understood that the connecting element 120 may be fixed to the wheel via a hub, and the connecting structure 121 is not limited to be thread. In this embodiment, an axis 122 of each of the two connecting elements 120 is located on an imaginary plane. Specifically, the axis 122 substantially extends, for example, along the direction Z, and the imaginary plane substantially extend along the Y-Z plane. The connecting structure 121 is constructed by a plurality of sawtooth threads 1210 when viewing at the imaginary plane (i.e., viewing in a direction substantially parallel to the direction X). Please refer to FIGS. 4 and 5 together. The sawtooth threads 1210 each have a tooth tip T. The sawtooth thread 1210 is divided into a first angle A1 and a second angle A2 by a connecting line L passing through a central point C of the respective tooth tip T and perpendicular to the axis 122. The first angle A1 is close to the middle segment 111, and the second angle A2 is away from the middle segment 111, wherein the first angle A1 is less than the second angle A2. Therefore, each sawtooth thread 1210 can have larger tooth thickness so as to further improve the structural strength against the axial-direction tensile force. In addition, the shape of each sawtooth thread 1210 is asymmetrical to the connecting line L; thus, when the spoke 100 is subjected to an axial-direction tensile force, parts of the sawtooth thread 1210 located on both sides of the connecting line L bear inconsistent forces, which can also prevent the sawtooth thread 1210 from loosing from the nipple N due to excessive local force. In an embodiment, the first angle A1 may be between 2-10 degrees, such as about 5 degrees; the second angle A2 may be between 40-50 degrees, such as about 45 degrees; but the specific data of degrees is not limited thereto.

Please refer to FIGS. 2 and 3 again. In this embodiment, the middle segment 111 and the two connecting segments 112 of the axle body 110 can be integrally formed to further improve the structural strength of the axle body 110 against the axial-direction tensile force. Moreover, the axle body 110 may be made by the injection molding process, but the present disclosure is not limited thereto. In addition, a material of the axle body 110 includes, for example, fiber composite or thermoplastic in this embodiment. For example, the aforementioned fiber composite may include fiberglass or carbon fiber, the aforementioned thermoplastic may include epoxy, PEEK, PAEK, PEKK etc., and the material of the axle body 110 is not limited by the present disclosure.

Please refer to FIGS. 2, 3 and 4 together. The friction enhancing structure 1120 may be protruded or be recessed from an outer peripheral surface of the middle segment 111 to enhance the friction between the connecting element 120 and the connecting segments 112 of the axle body 110, thereby improving the structural strength of the spoke 100 against the axial-direction tensile force. For example, each of the friction enhancing structures 1120 includes, for example, a plurality of concave portions R1 in this embodiment. The concave portions R1 are disposed at intervals along the axial direction of the axle body 110, and a convex portion R2 is formed between each two adjacent concave portions R1. Specifically, each concave portion R1 is, for example, recessed from the first peripheral surface OS1, and the concave portions R1 are disposed at intervals on the first peripheral surface OS1 so as to form a convex portion R2 between each two adjacent concave portions R1. Further, please continue to refer to FIG. 4. When the connecting element 120 is slid relative to the axle body 110 due to that the connecting element 120 is pulled by an excessive force along the axial direction, the connecting element 120 can be pushed by the convex portions R2 along a radial direction (substantially parallel to, for example, a direction Y) of the axle body 110, and therefore the connecting element 120 pushes the nipple N along the radial direction. Then, the nipple N can apply a reaction force to the connecting element 120 since the nipple N is pushed by the connecting element 120. As a result, the connecting element 120 can clamp the connecting segment 112 of the axle body 110 again to prevent the connecting element 120 from continuously sliding relative to the axle body 110. In addition, when the convex portions R2 push the connecting element 120 along the radial direction of the axle body 110, the connecting structure 121 of the connecting element 120 can be more closely abut to inner threads of the nipple N, so as to further prevent the connecting element 120 from loosing from the nipple N. Please refer to FIGS. 2, 3 and 4 together again. The convex portions R2 and the concave portions R1 make the first peripheral surface OS1 have a wavy surface in this embodiment. For example, the concave portions R1 can make the first peripheral surface OS1 have a plurality of concave curve surfaces at intervals, and the convex portion R2 forms a convex curve surface between each two adjacent concave curve surfaces. The concave curve surfaces and the convex curve surfaces staggered from each other together make a part of the first peripheral surface OS1 have a wavy surface. It can be understood that the specific shape of the friction enhancing structure 1120 is not limited to FIGS. 2 to 4. For example, the shape of the friction enhancing structure 1120 may include particles in an embodiment, and the specific shape of the friction enhancing structure 1120 is not limited in the present disclosure. Incidentally, the axle body 110 of this embodiment can have two opposite end surfaces 113, and the friction enhancing structure 1120 is located between the respective end surface 113 and the middle segment 111. The connecting element 120 further extends to wrap the respective end surface 113, so that the connecting element 120 can be more firmly fixed to the axle body 110.

In summary, in the spoke of the present disclosure, the connecting element wraps and is fixed to the axle body by means of injection molding, and the area of the axle body wrapped by the connecting element is disposed with the friction enhancing structure to enhance the friction between the connecting element and the axle body. Thus, based on the aforementioned structure, the connecting element can firmly wrap and be fixed to the axle body. Therefore, when the spoke is subjected to an axial-direction tensile force, the connecting element is not easily separated from the axle body, thereby improving the structural strength of the spoke against the axial-direction tensile force.

While the invention has been described in terms of what is presently considered to be the most practical and preferred embodiments, it is to be understood that the invention needs not be limited to the disclosed embodiment. On the contrary, it is intended to wrap various modifications and similar arrangements included within the spirit and scope of the appended claims which are to be accorded with the broadest interpretation so as to encompass all such modifications and similar structures.

What is claimed is:

1. A spoke, comprising:
an axle body, having a middle segment and two connecting segments, wherein the two connecting segments are respectively connected to two opposite sides of the middle segment, the two connecting segments each have a first peripheral surface, and the two first peripheral surfaces each are formed with a friction enhancing structure; and
two connecting elements, respectively wrapping at least a part of the two friction enhancing structures by means of injection molding, wherein the two connecting elements each have a second peripheral surface facing away from the axle body, and the two second peripheral surfaces each are formed with a connecting structure.

2. The spoke according to claim 1, wherein the two friction enhancing structures each comprise a plurality of concave portions, the concave portions are disposed at intervals along an axial direction of the axle body, and a convex portion is formed between each two adjacent concave portions.

3. The spoke according to claim 2, wherein the convex portions and the concave portions make the first peripheral surface have a wavy surface.

4. The spoke according to claim 1, wherein the two connecting elements each further extend to wrap a part of the middle segment.

5. The spoke according to claim 1, wherein a material of the connecting element comprises thermoplastic.

6. The spoke according to claim 5, wherein a material of the connecting element comprises epoxy, PEEK, PAEK or PEKK.

7. The spoke according to claim 1, wherein the connecting structure is thread, an axis of each of the two connecting elements is located on an imaginary plane, the connecting structure is constructed by a plurality of sawtooth threads when viewing at the imaginary plane, the sawtooth threads each have a tooth tip, the sawtooth threads each are divided into a first angle and a second angle by a connecting line passing through a central point of the respective tooth tip and perpendicular to the axis, the first angle is close to the middle segment, the second angle is away from the middle segment, and the first angle is less than the second angle.

8. The spoke according to claim 1, wherein the axle body has two end surfaces opposite to each other, the two friction enhancing structures are respectively located between the two end surfaces and the middle segment, and the two connecting elements further respectively extend to wrap the two end surfaces.

9. The spoke according to claim 1, wherein a material of the axle body comprises fiber composite or thermoplastic.

10. The spoke according to claim 1, wherein the middle segment and the two connecting segments are integrally formed.
